(19) United States
(12) Patent Application Publication
(10) Pub. No.: US 2019/0114003 A1
(43) Pub. Date: Apr. 18, 2019

(54) NANOWIRE CONTACT PADS WITH ENHANCED ADHESION TO METAL INTERCONNECTS

(71) Applicant: 3M INNOVATIVE PROPERTIES COMPANY, St. Paul, MN (US)

(72) Inventors: Jian Xia Gao, Singapore (SG); Ravi Palaniswamy, Singapore (SG); Peng Seong Ang, Singapore (SG)

(21) Appl. No.: 16/090,301

(22) PCT Filed: Mar. 28, 2017
(86) PCT No.: PCT/US2017/024433

§ 371 Date: Oct. 1, 2018

Related U.S. Application Data
(60) Provisional application No. 62/318,284, filed on Apr. 5, 2016.

(51) Int. Cl. G06F 3/044; G06F 3/045

(52) U.S. Cl. CPC G06F 3/044; G06F 2203/04112; G06F 3/045

(57) ABSTRACT

A capacitive touch sensitive apparatus includes a touch sensitive viewing area configured to detect a location of a touch applied to the touch sensitive viewing area by detecting a change in a coupling capacitance. A border area surrounds the touch sensitive viewing area. An electrically conductive first electrode includes an active portion disposed in and extending across the touch sensitive viewing area and an end portion at an end of the first electrode disposed in the border area for connection to a controller. The active portion of the first electrode has a substantially uniform first sheet resistance across the viewing area. The end portion of the first electrode is patterned in the form of an electrically conductive mesh including a plurality of interconnected conductive traces defining a plurality of interstices therebetween, the traces having substantially the first sheet resistance, and the interstices having a higher second sheet resistance.

### BACKGROUND

Capacitive touch sensors can be utilized as part of a touch-sensitive panel to enable human touch or gesture interactions with computers, smart phones, and other graphics-based screen interfaces. Capacitive touch sensor panels can be formed from rows and columns of electrically conductive traces separated by a dielectric. At their intersections, the traces essentially form two electrodes. A stimulus (for example, a touch or hover event) can be applied to one row with all other rows held at DC voltage levels. When a row is stimulated, a modulated output signal can be capacitively coupled onto the columns of the sensor panel, which are connected to analog channels generally referred to as event detection and demodulation circuits. The output values can then be transmitted to a controller and the resulting image displayed on a display screen of a host computer.

### SUMMARY

Touch sensitive panels for use in display devices include a top layer of glass upon which transparent column traces of a transparent conductor such as indium tin oxide (ITO) or antimony tin oxide (ATO) have been etched, and a bottom layer of glass upon which row traces of a transparent conductor have been etched. The top and bottom glass layers are separated by a dielectric in the areas between the row and column traces.

Components for touch sensitive panels can be efficiently produced at a relatively low cost by patterning (e.g., printing) a material including electrically conductive nanowires into electrical traces on a polymeric film substrate. The nanowires can be patterned in a roll-to-roll process where the substrate is unwound, converting operations such as printing and drying/curing are performed, and then the patterned substrate is wound again into a roll for further transport and processing.

The patterned conductive material formed by these roll-to-roll processes can be connected to an electronic circuit component to produce an electronic assembly such as, for example, a capacitive touch sensor for use in a touch-screen display. Nanowire contact pads at the ends of the nanowire traces outside the display screen viewing area in a border region near the edges of the sensor panel are bonded to conductive metal interconnect traces. The conductive metal interconnect traces are in turn connected to event detection and demodulation circuitry of the electronic display device. In some cases the nanowire pads and the conductive metal (for example, silver (Ag)) interconnect traces can adhere poorly to one another, which can increase resistance and reduce the reliability of the bonded joint.

In general, the present disclosure is directed to meshed contact pad designs and processes for connecting the meshed contact pads to metal interconnect circuit traces to form an electronic assembly that can be used as a component of an electronic device. The present disclosure is further directed to electronic devices such as, for example, touch-screen displays, which are constructed using these meshed contact pad designs and interconnection processes.

In one embodiment, the present disclosure is directed to a capacitive touch sensitive apparatus including a touch sensitive viewing area. The touch sensitive apparatus is configured to detect a location of a touch applied to the touch sensitive viewing area by detecting a change in a coupling capacitance. A border area surrounds the touch sensitive viewing area. An electrically conductive first electrode includes an active portion disposed in and extending across the touch sensitive viewing area and an end portion at an end of the first electrode disposed in the border area for connection to a controller. The active portion of the first electrode has a substantially uniform first sheet resistance across the viewing area, and the end portion of the first electrode patterned in the form of an electrically conductive mesh including a plurality of interconnected conductive traces defining a plurality of interstices therebetween. The traces have substantially the first sheet resistance, and the interstices have a higher second sheet resistance.

In another embodiment, the present disclosure is directed to a capacitive touch sensitive apparatus including an optically transparent substrate defining a touch sensitive viewing area surrounded by a border area. A plurality of spaced apart electrically conductive optically transparent first electrodes disposed on the substrate in the touch sensitive area extend along a first direction (x). A plurality of spaced apart electrically conductive optically transparent second electrodes disposed on the substrate in the touch sensitive area extend along a different second direction (y). The touch sensitive apparatus is configured to detect a location of a touch applied in the touch sensitive area by detecting a change in a coupling capacitance between a first and a second electrode traversing each other near the touch location. Each first and second electrode include a plurality of intersecting electrically conductive nanowires, each first and second electrode comprising an active portion disposed in and extending across the touch sensitive viewing area and an end portion at an end of the electrode disposed on the substrate in the border area. The end portion is patterned in the form of an electrically conductive regular mesh including a plurality of interconnected conductive traces defining a plurality of insulative interstices therebetween. A plurality of electrically conductive bus lines are disposed on the substrate in the border area, each bus line having a first end portion terminating at a connection region in the border area for connection to a controller and an opposite second end portion terminating at and substantially covering the plurality of interconnected conductive traces and the plurality of insulative interstices of a corresponding first or second electrode, and the second end portion of the bus line adhered to the substrate in the plurality of interstices.

In another aspect, the present disclosure is directed to a capacitive touch sensitive apparatus including an electrically conductive unitary first electrode having a middle portion extending between opposing first and second end portions. The first electrode includes a substantially uniform distribution of intersecting electrically conductive nanowires, and the nanowires in the first end portion are patterned as an electrically conductive regular mesh including a plurality of interconnected regularly arranged conductive traces (415) defining a plurality of interstices (420) therebetween. The traces have a first sheet resistance, and the interstices having a higher second sheet resistance.

In another aspect, the present disclosure is directed to a method for bonding a metallic trace to a nanowire-containing contact pad overlain by a resist material, the method including patterning the nanowire-containing contact pads to form a mesh pattern of conductive traces having a first sheet resistance and interspersed with interstitial areas forming a patterned dielectric region having a second sheet resistance higher than the first sheet resistance, wherein a ratio of the area of the patterned dielectric layer to the area of the conductive metal mesh in the contact pads is about 1:1 to about 10:1; and bonding the contact pad to a metallic interconnect trace to form an electrical interconnection, wherein the metal forming the interconnect trace is applied on the contact pads to coat the mesh-patterned metallic traces and the patterned dielectric region such that the metal contacts the substrate surface in the interstices of the patterned dielectric region.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic, cross-sectional view of a conductive nanowire layer on a substrate, wherein the conductive nanowire layer is overlain by a patterned resist matrix material.

FIG. 2 is a schematic, cross-sectional view of the construction of FIG. 1 overlain by a strippable polymer layer.

FIG. 3 is a schematic, cross-sectional view of the construction of FIG. 2 following removal of the strippable polymer layer.

FIG. 3A is a schematic, cross-sectional view of a portion of the conductive nanowire layer following removal of the strippable polymer layer, and illustrating protruding nanowires.

FIG. 4A is a schematic, overhead view of a portion of a capacitive touch sensitive apparatus.

FIG. 4B is a schematic, cross-sectional view of a portion of the capacitive touch sensitive apparatus of FIG. 4A.

FIG. 4C is a schematic, cross-sectional view of an end portion of a conductive electrode in the capacitive touch sensitive apparatus of FIG. 4A.

FIG. 4D is a schematic, overhead view of an end portion of a conductive electrode in the capacitive touch sensitive apparatus of FIG. 4A.

FIG. 5 is an exploded perspective view of a capacitive touch sensor panel including the capacitive touch sensitive apparatus of the present disclosure.

Like symbols in the drawings indicate like elements.

### DETAILED DESCRIPTION

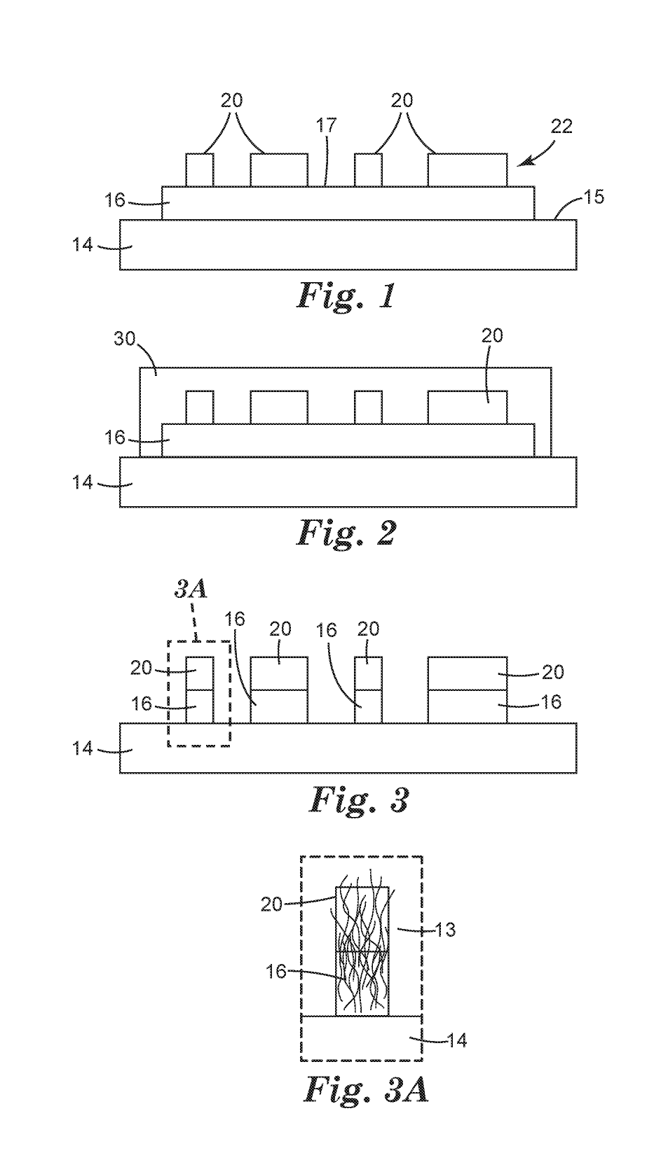

Referring now to FIG. 1, a substrate 14 is coated with a conductive layer 16 including nanowires. The conductive nanowire layer 16 is substantially continuous over at least a portion of a first major surface 15 of the substrate 14 and desirably over at least 50%, 60%, 70%, 80%, or 90% of the area of the first major surface. The conductive nanowire layer 16 may be coated continuously along the substrate, or may be applied in discrete blocks or rectangles, leaving uncoated substrate areas between them, with the blocks or rectangles having a size similar to the overall size of the intended touch screen being produced. By “substantially continuous” it is meant the nanowires are applied at a sufficient density to render the surface of the substrate conductive, it being recognized that a nanowire layer will include individual wires with openings or spaces between them.

The conductive nanowire layer 16 includes conductive nanowires. In this application, the term nanowire refers to conductive metal or non-metallic filaments, fibers, rods, strings, strands, whiskers, or ribbons having high aspect ratios (e.g., higher than 10). Examples of non-metallic conductive nanowires include, but are not limited to, carbon nanotubes (CNTs), metal oxide nanowires (e.g., vanadium pentoxide), metalloid nanowires (e.g., silicon), conductive polymer fibers and the like.

As used herein, “metal nanowire” refers to a metallic wire including elemental metal, metal alloys or metal compounds (including metal oxides). At least one cross sectional dimension of the metal nanowire is less than 500 nm, or less than 200 nm, and more preferably less than 100 nm. As noted, the metal nanowire has an aspect ratio (length:width) of greater than 10, preferably greater than 50, and more preferably greater than 100. Suitable metal nanowires can be based on any metal, including without limitation, silver, gold, copper, nickel, and gold-plated silver.

The metal nanowires can be prepared by known methods in the art. In particular, silver nanowires can be synthesized through solution-phase reduction of a silver salt (e.g., silver nitrate) in the presence of a polyol (e.g., ethylene glycol) and polyvinyl pyrrolidone). Large-scale production of silver nanowires of uniform size can be prepared according to the methods described in, e.g., Xia, Y. et al., Chem. Mater. (2002), 14, 4736-4745, and Xia, Y. et al., Nanoletters (2003) 3(7), 955-960. More methods of making nanowires, such as using biological templates, are disclosed in WO 2007/022226.

In certain embodiments, the nanowires are dispersed in a liquid and a nanowire layer on the substrate is formed by coating the liquid containing the nanowires onto the substrate and then allowing the liquid to evaporate (dry) or cure. The nanowires are typically dispersed in a liquid to facilitate more uniform deposition onto the substrate by using a coater or sprayer.

Any non-corrosive liquid in which the nanowires can form a stable dispersion (also called “nanowire dispersion”) can be used. Preferably, the nanowires are dispersed in water, an alcohol, a ketone, ethers, hydrocarbons or an aromatic solvent (benzene, toluene, xylene, etc.). More preferably, the liquid is volatile, having a boiling point of no more than 200 degrees C. (° C.), no more than 150° C., or no more than 100° C.

In addition, the nanowire dispersion may contain additives or binders to control viscosity, corrosion, adhesion, and nanowire dispersion. Examples of suitable additives or binders include, but are not limited to, carboxy methyl cellulose (CMC), 2-hydroxy ethyl cellulose (HEC), hydroxy propyl methyl cellulose (HPMC), methyl cellulose (MC), poly vinyl alcohol (PVA), tripropylene gylcol (TPG), and xanthan gum (XG), and surfactants such as ethoxylates, alkoxylates, ethylene oxide and propylene oxide and their copolymers, sulfonates, sulfates, disulfonate salts, sulfosuccinates, phosphate esters, and fluorosurfactants (e.g., those available under the trade designation Zonyl from DuPont).

In one example, a nanowire dispersion, or “ink” includes, by weight, from 0.0025% to 0.1% surfactant (e.g., a preferred range is from 0.0025% to 0.05% for Zonyl® FSO-100), from 0.02% to 4% viscosity modifier (e.g., a preferred range is 0.02% to 0.5% for HPMC), from 94.5% to 99.0% solvent and from 0.05% to 1.4% metal nanowires. Representative examples of suitable surfactants include Zonyl FSN, Zonyl FSO, Zonyl FSH, Triton (x100, x114, x45), Dynol (604, 607), n-Dodecyl b-D-maltoside and Novek. Examples of suitable viscosity modifiers include hydroxypropyl methyl cellulose (HPMC), methyl cellulose, xanthan gum, polyvinyl alcohol, carboxy methyl cellulose, hydroxy ethyl cellulose. Examples of suitable solvents that may be present in a nanowire dispersion that includes the aforementioned binders or additives include water and isopropanol.

If it is desired to change the concentration of the dispersion from that disclosed above, the percent of the solvent can be increased or decreased. In preferred embodiments the relative ratios of the other ingredients, however, can remain the same. In particular, the ratio of the surfactant to the viscosity modifier is preferably in the range of about 80:1 to about 0.01:1; the ratio of the viscosity modifier to the nanowires is preferably in the range of about 5:1 to about 0.000625:1; and the ratio of the nanowires to the surfactant is preferably in the range of about 560:1 to about 5:1. The ratios of components of the dispersion may be modified depending on the substrate and the method of application used. The preferred viscosity range for the nanowire dispersion is between about 1 and 1000 cP (0.001 and 1 Pa-s).

The substrate 14 in FIG. 1 can be rigid or flexible. The substrate can be clear or opaque. Suitable rigid substrates include, for example, glass, polycarbonates, acrylics, and the like. Suitable flexible substrates include, but are not limited to: polyesters (e.g., polyethylene terephthalate (PET), polyester naphthalate (PEN), and polycarbonate (PC)), polyolefins (e.g., linear, branched, and cyclic polyolefins), polyvinyls (e.g., polyvinyl chloride, polyvinylidene chloride, polyvinyl acetals, polystyrene, polyacrylates, and the like), cellulose ester bases (e.g., cellulose triacetate, cellulose acetate), polysulphones such as polyethersulphone, polyimides, silicones and other conventional polymeric films. Additional examples of suitable substrates can be found in, e.g., U.S. Pat. No. 6,975,067.

Optionally, the surface of the substrate can be pre-treated to prepare the surface to better receive the subsequent deposition of the nanowires. Surface pre-treatments serve multiple functions. For example, they enable the deposition of a uniform nanowire dispersion layer. In addition, they can immobilize the nanowires on the substrate for subsequent processing steps. Moreover, the pre-treatment can be carried out in conjunction with a patterning step to create patterned deposition of the nanowires. As described in WO 2007/02226, pre-treatments can include solvent or chemical washing, heating, deposition of an optional patterned intermediate layer to present an appropriate chemical or ionic state to the nanowire dispersion, as well as further surface treatments such as plasma treatment, ultraviolet radiation (UV)-ozone treatment, or corona discharge.

The nanowire dispersion that forms the nanowire layer 16 can be applied to the substrate at a given thickness selected to achieve desired optical and electrical properties. This application is performed using known coating methods, such as slot coating, roll coating, Mayer rod coating, dip coating, curtain coating, slide coating, knife coating, gravure coating, notch bar coating or spraying, yielding a conductive nanowire layer on the substrate. The nanowire layer 16 may also be deposited non-continuously using a printing technique including, but not limited to, gravure, flexographic, screen, letterpress, ink-jet printing, and the like. This coating step can be performed either as a roll-to-roll process or in a piece-part fashion.

Following the deposition, the liquid of the dispersion is typically removed by evaporation. The evaporation can be accelerated by heating (e.g., using a dryer). The resulting conductive nanowire layer may require post-treatment to render it more electrically conductive. This post-treatment can be a process step involving exposure to heat, plasma, corona discharge, UV-ozone, or pressure as further described in WO 2007/02226. Optionally coating the substrate with a nanowire layer can be followed by hardening or curing the nanowire layer.

Optionally, the conductive nanowire layer 16 can be coated onto the substrate 14 by a process wherein the layer is delivered to the substrate surface 15 using means other than liquid dispersion coating. For example, a nanowire layer can be dry-transferred to a substrate surface from a donor substrate. As a further example, nanowires can be delivered to a substrate surface from a gas phase suspension.

In one specific embodiment, a layer of aqueous dispersion of nanowires (for example, dispersions available from Cambrios under the trade designation ClearOhm Ink) was applied to a PET substrate in the range 10.0 to 25 microns thick using a slot die coating technique. The coating formulation (e.g. % total solids by wt. and % silver nanowire solids by wt.) can be selected, along with the coating and drying process conditions, to create a nanowire layer with designed electrical and optical properties, e.g. a desired sheet resistance (Ohm/Sq) and optical properties such as transmission (%) and haze (%).

The conductive nanowire layer 16 that results from coating nanowires on a substrate (e.g., from a nanowire dispersion) includes nanowires and optionally binder or additives. The nanowire layer preferably includes an interconnected network of nanowires. The nanowires that make up the nanowire layer are preferably electrically connected to each other, leading approximately or effectively to a sheet conductor. The nanowire layer includes open space between the individual nanowires that make up the layer, leading to at least partial transparency (i.e., light transmission). Nanowire layers having an interconnected network of nanowires with open space between the individual nanowires may be described as transparent conductor layers.

Typically, the optical quality of the nanowire layer 16 can be quantitatively described by measurable properties including light transmission and haze. “Light transmission” refers to the percentage of an incident light transmitted through a medium. In various embodiments, the light transmission of the conductive nanowire layer is at least 80% and can be as high as 99.9%. In various embodiments, the light transmission of the conductive layer such as the nanowire layer is at least 80% and can be as high as 99.9% (e.g., 90% to 99.9%, 95% to 99.5%, 97.5% to 99%). For a transparent conductor in which the nanowire layer is deposited or laminated (e.g., coated) on a substrate (e.g., a transparent substrate), the light transmission of the overall structure may be slightly diminished as compared with the light transmission of the constituent nanowire layer. Other layers that may be present in combination with the conductive nanowire layer and the substrate, such as an adhesive layer, anti-reflective layer, anti-glare layer, may improve or diminish the overall light transmission of the transparent conductor. In various embodiments, the light transmission of the transparent conductor comprising a conductive nanowire layer deposited or laminated on a substrate and one or more others layers can be at least 50%, at least 60%, at least 70%, at least 80%, at least 90%, or at least 91%, and may be as high as at least 91% to 99%.

Haze is an index of light diffusion. It refers to the percentage of the quantity of light separated from the incident light and scattered during transmission. Unlike light transmission, which is largely a property of the medium, haze is often a production concern and is typically caused by surface roughness and embedded particles or compositional heterogeneities in the medium. In accordance with ASTM Standard No. D1003-11, haze can be defined as the proportion of transmitted light that is deflected by an angle greater than 2.5 degrees. In various embodiments, the haze of the conductive nanowire layer is no more than 10%, no more than 8%, no more than 5%, no more than 2%, no more than 1%, no more than 0.5%, or no more than 0.1% (e.g., 0.1% to 5% or 0.5 to 2%). For a transparent conductor in which the conductive nanowire layer is deposited or laminated (e.g., coated) on a substrate (e.g., a transparent substrate), the haze of the overall structure may be slightly increased as compared with the haze of the constituent nanowire layer. Other layers that may be present in combination with the conductive nanowire layer and the substrate, such as an adhesive layer, anti-reflective layer, anti-glare layer, may improve or diminish the overall haze of the transparent conductor comprising a nanowire layer. In various embodiments, the haze of the transparent conductor comprising a conductive nanowire layer deposited or laminated on a substrate can be no more than 10%, no more than 8%, no more than 5%, no more than 2%, no more than 1%, no more than 0.5%, or no more than 0.1% (e.g., 0.1% to 5% or 0.5 to 2%). “Clarity” is the proportion of transmitted light that is deflected by an angle less than 2.5 degrees.

The sheet resistance, transmission, and haze of the conductive nanowire layer 16 can be tailored by varying certain attributes of the layer and its constituent materials such as the nanowires. Regarding the nanowires, they can be varied, for example, in composition (e.g., Ag, Cu, Cu—Ni alloy, Au, Pd), length (e.g., 1 micrometer, 10 micrometers, 100 micrometers, or greater than 100 micrometers), cross-sectional dimension (e.g., diameter of 10 nanometers, 20 nanometers, 30 nanometers, 40 nanometers, 50 nanometers, 75 nanometers, or greater than 75 nanometers). Regarding the conductive layer comprising the nanowires, it can be varied, for example, in its other components (e.g., cellulosic binders, processing aids such as surfactants, or conductance enhancers such as conducting polymers) or its area density of nanowires (e.g., greater than 10 per square millimeter, greater than 100 per square millimeter, greater than 1000 per square millimeter, or even greater than 10000 per square millimeter). Accordingly, the sheet resistance of the conductive layer or nanowire layer may be less than 1,000,000 Ohm/Sq, less than 1,000 Ohm/Sq, less than 100 Ohm/Sq, or even less than 10 Ohm/Sq (e.g., 1 Ohm/Sq to 1,000 Ohm/Sq, 10 Ohm/Sq to 500 Ohm/Sq, 20 Ohm/Sq to 200 Ohm/Sq, or 25 to 150 Ohm/Sq). The transmission of the conductive layer or nanowire layer may be at least 80% and can be as high as 99.9% (e.g., 90% to 99.9%, 95% to 99.5%, or 97.5% to 99%). The haze of the conductive layer or nanowire layer may be no more than 10%, no more than 8%, no more than 5%, no more than 2%, no more than 1%, no more than 0.5%, or no more than 0.1% (e.g., 0.1% to 5% or 0.5 to 2%).

Referring again to FIG. 1, a pattern of a resist matrix material is applied on the conductive nanowire layer 16 to generate on the substrate 14 one or more first regions 17 of exposed conductive nanowire layer and one or more second regions 22 of the resist matrix material (for example, a circuit pattern for a touch screen). The resist matrix material 20 can be applied to or patterned on the conductive nanowire layer 16, for example, by printing, and upon being so applied renders the conductive nanowire layer more adherent or protected on the substrate.

In certain embodiments, the matrix material 20 includes a polymer and desirably an optically clear polymer. Examples of suitable polymeric resist matrix materials include, but are not limited to: polyacrylics such as polymethacrylates, polyacrylates and polyacrylonitriles, polyvinyl alcohols, polyesters (e.g., polyethylene terephthalate (PET), polyester naphthalate (PEN), and polycarbonates (PC)), polymers with a high degree of aromaticity such as phenolics or cresol-formaldehyde (Novolacs®), polystyrenes, polyvinyltoluene, polyvinylxylene, polyimides, polyamides, polyamideimides, polyetherimides, polysulfides, polysulfones, polyphenylenes, and polyphenyl ethers, polyurethane (PU), epoxy, polyolefins (e.g. polypropylene, polymethylpentene, and cyclic olefins), acrylonitrile-butadiene-styrene copolymer (ABS), cellulosics, silicones and other silicon-containing polymers (e.g. polysilsesquioxanes and polysilanes), polyvinylchloride (PVC), polyacetates, polynorbomenes, synthetic rubbers (e.g. EPR, SBR, EPDM), and fluoropolymers (e.g., polyvinylidene fluoride (PVDF), polytetrafluoroethylene (PTFE) or polyhexafluoropropylene), copolymers of fluoro-olefin and hydrocarbon olefin (e.g., Lumiflon®), and amorphous fluorocarbon polymers or copolymers (e.g., CYTOP® by Asahi Glass Co., or Teflon® AF by DuPont Corp.).

In other embodiments, the resist matrix material 20 includes a prepolymer. A “prepolymer” refers to a mixture of monomers or a mixture of oligomers or partial polymers that can polymerize and/or crosslink to form the polymeric matrix, as described herein. It is within the knowledge of one skilled in the art to select, in view of a desirable polymeric matrix, a suitable monomer or partial polymer.

In some embodiments, the prepolymer is photo-curable, i.e., the prepolymer polymerizes and/or cross-links upon exposure to irradiation. Resist matrix materials based on photo-curable prepolymers can be patterned by exposure to irradiation in selective regions, or by selective placement of the prepolymer on the substrate followed by uniform exposure to irradiation. In other embodiments, the prepolymer is thermal-curable, which can be patterned in a similar manner, though exposure to a heat source is used in place of exposure to irradiation.

Typically, the resist matrix material 20 is applied as a liquid. The resist matrix material may optionally include a solvent (e.g., during application). Optionally, the solvent may be removed during the application process, for example before over-coating with the strippable polymer layer. Any non-corrosive solvent that can effectively solvate or disperse the matrix material can be used. Examples of suitable solvents include water, an alcohol, a ketone, an ether, tetrahydrofuran, hydrocarbons (e.g. cyclohexane) or an aromatic solvent (benzene, toluene, xylene, etc.). The solvent can be volatile, having a boiling point of no more than 200° C., no more than 150° C., or no more than 100° C. In other embodiments, the resist matrix material may be photo-curable.

In some embodiments, the resist matrix material 20 may include a cross-linker, a polymerization initiator, stabilizers (including, for example, antioxidants, and UV stabilizers for longer product lifetime and polymerization inhibitors for greater shelf-life), surfactants and the like. In some embodiments, the matrix material 20 may further include a corrosion inhibitor. In some embodiments, the resist matrix material itself is conductive. For example, the matrix can include a conductive polymer. Conductive polymers are known in the art, including without limitation: polyanilines, polythiophenes, and polydiacetylenes.

In some embodiments, the resist matrix material has a thickness of about 10 nanometers and about 300 nanometers, about 20 nanometers to about 200 nanometers, about 40 nanometers to 200 nanometers, or about 50 nanometers to 200 nanometers.

In some embodiments, the resist matrix material has a refractive index of between about 1.30 and 2.50, between about 1.40 and 1.70, or between about 1.35 and 1.80.

The resist matrix material 20 adds integrity to the conductive nanowire layer 16 and can promote improved adhesion of the conductive nanowire layer 16 to the surface 15 of the substrate 14.

Typically, the resist matrix material 20 is an optically clear material. A material is considered optically clear if the light transmission of the material is at least 80% in the visible region (400 nm-700 nm). Unless specified otherwise, all the layers (including the substrate) described herein are preferably optically clear. The optical clarity of the resist matrix material is typically determined by a multitude of factors, including without limitation: the refractive index (RI), thickness, smoothness, consistency of the RI throughout the thickness, surface (including interface) reflection, and scattering caused by surface roughness and/or embedded particles.

As discussed above, the resist matrix material 20 may be cured and/or hardened into a protective layer in selected regions forming a pattern over the conductive nanowire layer 16. “Cure or curing” refers to a process where monomers or partial polymers (e.g. oligomers comprising fewer than 150 monomer units) polymerize so as to form a solid polymeric matrix, or where polymers cross-link. Suitable polymerization or cross-linking conditions are well known in the art and include by way of example, heating the monomer, irradiating the monomer with visible or ultraviolet (UV) light, electron beams, and the like. Alternatively, “harden(s) or hardening” may be caused by solvent removal during drying of a resist matrix material, for example without polymerization or cross-linking.

The resist matrix material 20 is patterned by a suitable patterning process. Suitable patterning processes include subtractive methods such as photolithography (wherein the resist matrix material is a photoresist). Suitable patterning processes also include direct printing. As discussed above, hardening or curing of the printed resist occurs prior to the next process step. Suitable printers or patterning methods are known and include the illustrated flexographic printer, gravure printing, ink jet printing, screen printing, spray coating, needle coating, photolithographic patterning, and offset printing.

Suitable patterns involve features whose smallest dimension, either width or length, are greater than zero micron such as greater than 0.001 micron and less than 1 micron, less than 10 microns, less than 100 microns, less than 1 mm, or less than 10 mm. Any upper bound on the feature size is limited only by the size of the substrate on which printing occurs. In the case of roll-to-roll printing, this is effectively indefinite in the machine direction of the web. These features can take on any shape that can be patterned, such as stars, squares, rectangles, or circles. Often the features will be parallel lines or a grid sensitive to touch for use as a component in a touch screen.

Referring to FIG. 2, a strippable polymer material 30 is applied over the conductive nanowire layer 16 and the resist layer 20 on the substrate 14 (e.g., coated; or patterned, for example by printing, onto a one or more regions of the conductive nanowire layer 16 on the substrate 14). Upon being so applied, the strippable polymer material 30 renders the conductive nanowire layer 16 removable by peeling (e.g., in the one or more regions where the strippable polymer material 30 is patterned). In general, the strippable polymer material 30 applied to the conductive nanowire layer 16 is less adherent to the substrate than a resist matrix material applied to the same conductive nanowire layer coated on the substrate. In general, a strippable polymer material 30 applied to the resist matrix material 20 that is applied to the conductive nanowire layer 16 is less adherent to the resist matrix material 20 than the resist matrix material is adherent to the conductive nanowire layer 16.

Suitable strippable polymer materials readily coat and adhere to the conductive nanowire layer 16 while not unduly adhering to either the substrate 14 or the resist matrix material 20 such that the layer 30 can be peeled from both the resist matrix material 20 and the substrate 14. The selection of chemical composition for the strippable polymer layer 30 depends on the selection of the substrate 14, the resist matrix material 20, and the specific composition of the conductive nanowire layer 16.

One suitable strippable polymer layer comprises polyvinyl alcohol (PVA). It has been found in some embodiments that a molecular weight of approximately 8,000 to 9,000 Daltons for the PVA is preferred. A suitable commercially available coating composition comprising PVA is MacDermid's Print & Peel available from MacDermid Autotype, Inc., Rolling Meadows, Ill. Print and Peel is a water based screen printable varnish designed to be selectively printed onto a range of surface finishes to act as an easily removable protective mask. Surprisingly, it was found that the adhesion of this composition to the nanowire layer 16 was sufficient to completely remove it from the substrate 14 in unwanted areas while readily leaving the nanowire areas covered by the resist pattern 26 attached to the substrate during the subsequent peeling operation.

Another commercially available strippable polymer material is Nazdar 303440WB Waterbase Peelable Mask available from Nazdar Ink Technologies, Shawnee, Kans. Another suitable strippable polymer layer can be formulated by mixing poly vinyl alcohol (PVA) and Triton X-114 available from Union Carbide (or another suitable surfactant) and deionized water. One suitable formulation can comprise 20% by weight PVA (8,000 to 9,000 Da molecular weight), 2% by weight Triton X-114, and the balance deionized water.

Preferably, the strippable polymer layer 30 is delivered to the resist matrix material 20 patterned substrate 14 in a liquid state. The strippable polymer layer 30 is formed by applying a strippable polymer layer-forming liquid to the resist matrix material patterned substrate. A dryer can be optionally used to harden or cure the strippable polymer layer 30 after application by a coater. The strippable polymer layer-forming liquid is applied to the substrate using known application methods, such as slot coating, gravure coating, roll coating, flood coating, notch bar coating, spraying, thermal compression lamination, or vacuum lamination.

As shown in FIG. 1, the surface of the substrate 15 having a conductive nanowire layer 16 and a resist matrix material pattern 20 includes: i) one or more first regions 17 of exposed conductive nanowire layer 16 and ii) one or more second regions 22 of conductive nanowire layer overlain by resist matrix material. Generally, the resist matrix material regions are raised with respect to the exposed conductive nanowire layer regions. Generally, at the border between a resist matrix material region and an exposed conductive nanowire layer region, a change in relief exists. An example of such a change in relief is a step edge between the exposed conductive layer region and the resist matrix material region of the resist matrix material. The step edge may have a height (as approximated by the thickness of the resist matrix material in the aforementioned example) and it may have a lateral extent (e.g., distance, approximately in a plane parallel to the substrate, over which the step edge exists). Depending upon the change in relief, and depending upon the in-plane geometries of the resist matrix material and exposed conductive layer regions (e.g., shapes and sizes), making contact to substantially the entire exposed conductive material surface with the strippable polymer layer may be challenging. If a portion of the exposed conductive nanowire layer region is not contacted by the strippable polymer layer, that portion may not be removed successfully or with high pattern fidelity, during the subsequent peeling step. Accordingly, in some embodiments, the strippable polymer-forming liquid layer is applied to the resist matrix material patterned substrate, wherein at least 50%, preferably at least 75%, more preferably at least 90%, more preferably at least 95%, more preferably at least 99%, and most preferably 100% of the exposed conductive layer is contacted by the strippable polymer layer material.

Regarding the strippable polymer layer-forming liquid that is delivered to the resist matrix material patterned substrate, it may be a polymer solution, a polymer dispersion, a monomer solution, a monomer, a mixture of monomers, or a melt. The liquid may include minor amounts of secondary components (e.g., photoinitiators, surface active agents, viscosity modifiers). The strippable polymer layer is not delivered as a solid (e.g., a viscoelastic solid, such as a cross-linked pressure sensitive adhesive exhibiting appreciable yield stress that would limit the degree of contact between the adhesive and the exposed conductive or nanowire material in the exposed nanowire material regions). Application of the strippable layer in a liquid state leads to high resolution (high fidelity) patterning of the conductive or nanowire layer after peeling the strippable polymer layer from the resist matrix material patterned substrate.

The viscosity of the strippable polymer layer-forming liquid can be selected with consideration of the application method that will be used to deliver it to the resist matrix material patterned substrate. For example, for slot coating, roll coating, gravure coating, flood coating, notch bar coating, or spraying of a polymer solution, monomer, or monomer solution: the viscosity can be between 1 cps and 10,000 cps (0.001 and 10 Pa-s), preferably between 10 cps and 2,500 cps (0.01 and 2.5 Pa-s). For thermal compression or vacuum lamination of a polymer melt, the viscosity may be between 10,000 cps and 100,000,000 cps (10 Pa-s and 100 Pa-s). The strippable polymer layer-forming liquid preferably has zero yield stress. Some useful strippable polymer layer-forming liquids may develop a very low yield stress, preferably less than 100 Pa, more preferably less than 50 Pa, even more preferably less than 5 Pa, even more preferably less than 1 Pa.

The strippable polymer layer 30 is substantially continuous over at least a portion of the first major surface of the substrate and desirably over at least 50%, 60%, 70%, 80%, or 90% of the first major surface's area. The strippable polymer layer may be applied in discrete blocks or rectangles leaving uncoated substrate areas between them with the blocks or rectangles having a size similar to the overall size of the intended touch screen being produced. By “substantially continuous” it is meant the strippable polymer layer is applied over multiple patterned resist matrix material lines, traces, or discrete features such that the strippable polymer layer covers not only the patterned resist matrix material 20 but also the conductive nanowire layer 16 present between the patterned resist matrix material. Typically, a uniform thickness and continuous coating of strippable polymer material is applied over at least some portion of the substrate, but not necessarily the entire width or length of the substrate. For example, the middle portion of the substrate could be coated with the strippable polymer material while a strip or margin along each edge is left uncoated.

The approach described here has several advantages. First, by casting the strippable polymer layer from as a liquid, it is possible to create very intimate contact between the strippable polymer layer and the conductive nanowire layer. Second, this intimate contact prevents removed portions of the conductive nanowire layer from falling onto the substrate after the strippable polymer layer is removed, avoiding contamination of the substrate that could substantially decrease product yields. Finally, after the over coating step, the strippable polymer layer can remain in place during transportation, handling, and converting operations, serving as a protective film and eliminating the need for an additional liner to be applied after the fact, which could be the case if the conductive nanowire material were patterned using laser ablation.

The strippable polymer layer is applied with a sufficient thickness to cover both the patterned resist matrix material 20 and the conductive nanowire layer 16. Typical thicknesses for the strippable polymer layer are from about 2 μm to about 10 μm, or from 10 μm to 25 μm, or from 25 μm to 100 μm. After applying the strippable polymer layer, the layer is hardened or cured as needed. An optional dryer can be used to speed up the hardening or curing process. A thinner layer of strippable polymer material is preferred, since it requires less energy to remove the solvent from the coating composition, leading to faster drying, and therefore, processing times. In some embodiments, an optional pre-mask (not shown in FIG. 2) may be laminated to a surface of the strippable polymer layer 30 to provide mechanical support during the peeling step. Referring now to FIG. 3, the strippable polymer layer 30 is peeled away. The strippable polymer layer 30 may be removed by a wide variety of techniques such as, for example, by passing the substrate 14 with all of the applied layers though a delaminating nip (not shown in FIG. 3). The strippable polymer layer 30 with attached conductive nanowire material 16 in areas of the substrate unprotected by the patterned (e.g., printed) resist matrix material 20 is removed from the substrate 14. Peeling the strippable polymer layer 30 from the substrate 14 removes the conductive nanowire material 16 in selected regions of the substrate thereby forming a patterned nanowire layer in which each region of the nanowire layer remaining on the substrate 14 is overlain by resist matrix material 20.

FIG. 3A illustrates a magnified, schematic cross-sectional view of a region of the conductive nanowire layer 16 overlain by the resist matrix material 20 following removal of the strippable polymer layer. A plurality of nanowires 13 originate in the nanowire layer 16 and cross into the resist matrix material 20. The nanowires 13 protrude from the conductive nanowire layer 16 and the overlying resist matrix material 20. At least some of the nanowires 13 extend above the resist matrix material 20 and provide sites for further electrical interconnection with the conductive nanowire layer 16.

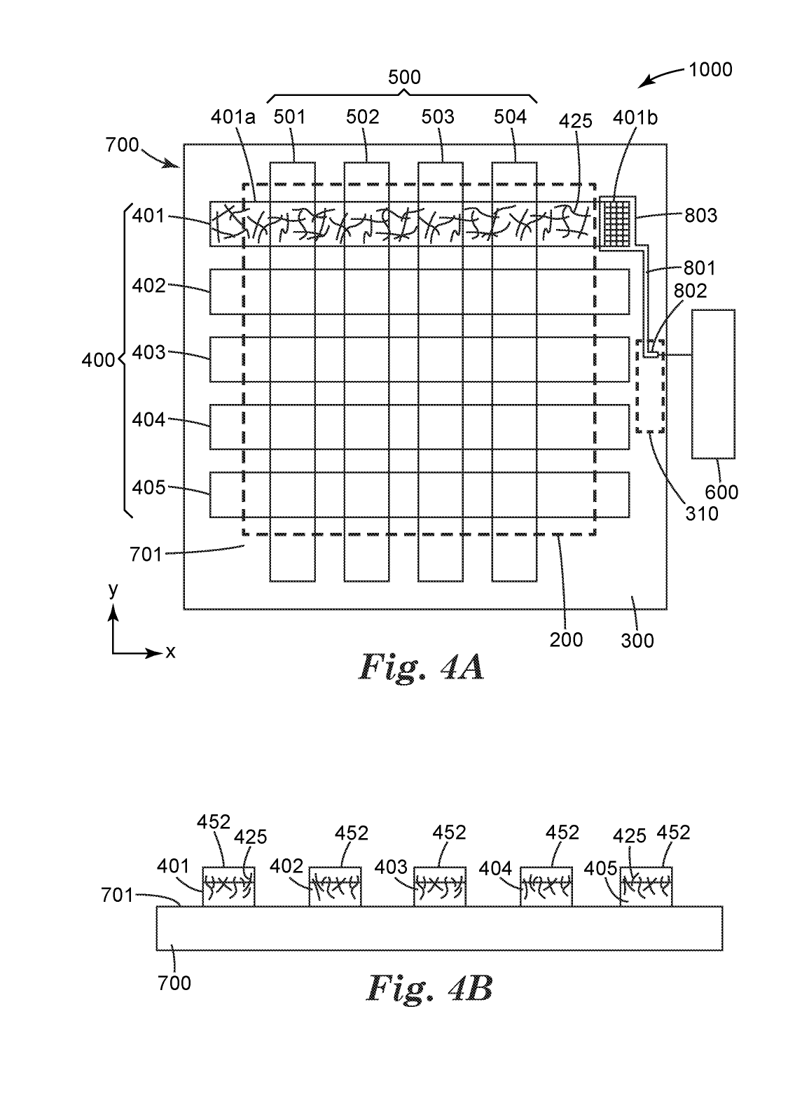

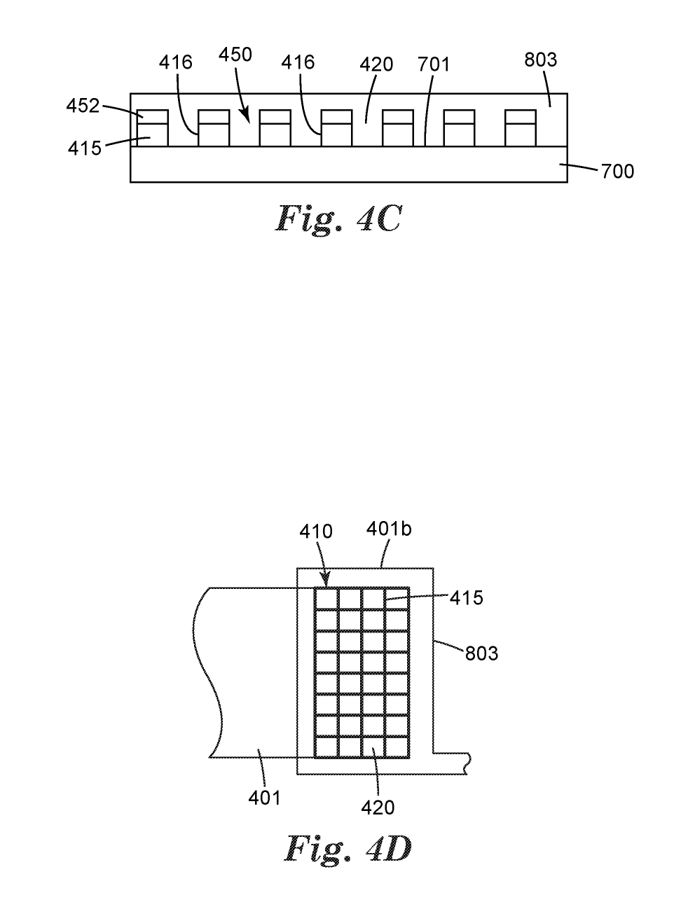

FIG. 4A is a schematic overhead view, not to scale, of a portion of an embodiment of a capacitive touch sensitive panel 1000 formed on a major surface 701 of a polymeric film substrate 700 using the patterning process described in FIGS. 1-3 above. The touch sensitive panel 1000 includes a touch sensitive viewing area 200 enclosing a touch sensitive apparatus including overlapping conductive traces configured to detect a location of a touch applied to the touch sensitive viewing area 200 by detecting a change in a coupling capacitance. In the embodiment of FIG. 4A, a border area 300 surrounds the touch sensitive viewing area 200, although in other embodiments the border area 300 may only partially surround the touch sensitive viewing area 200.

The touch sensitive apparatus includes a first arrangement of transparent electrically conductive row sense electrodes 400, which overlap a second arrangement of transparent electrically conductive column sense electrodes 500. As shown in FIG. 4B, the row electrodes 400 include parallel lines 401-405 of layers on the surface 701 including conductive nanowires 425, each nanowire layer covered by a layer 452 of a resist material. Similarly, the column electrodes include parallel columns 501-505 of a conductive material, and in some embodiments the columns 501-505 further include nanowire layers overlain by a resist material, although any conductive material may be used for the columns 501-505, including conductive metals such as silver, gold, copper, ITO, ATO, and the like.

In the embodiment of FIG. 4A, the row electrode 401 includes an active portion 401a within the touch sensitive viewing area 200 of the touch sensitive display. In some embodiments, the active portion 401a of the row electrode 401 has a substantially uniform distribution of conductive nanowires, which provide the active portion 401a with a substantially uniform first sheet resistance across the viewing area 200 of the touch sensitive display. The row electrode 401 further includes an end portion 401b in the border region 300 of the display. The end portion 401b resides on and contacts the surface 701 of the polymeric film substrate 700, and provides a contact pad for connecting the active portion 401a of the row electrode 401 to a second end 803 of an electrically conductive metal bus line 801 extending within the border area 300. A first end 802 of the bus line 801 terminates in a connection region 310, which may be electrically connected to control circuitry 600 including a controller and sense detection and demodulation circuits.

The control circuitry may be connected to the connection region 310 by a wide variety of techniques including, but not limited to, soldering, or via a flex circuit (not shown in FIG. 4A). While the embodiment shown in FIG. 4A includes a single end portion 401b of the row electrode 401 connected to the bus line 801, it should be understood that a wide variety of interconnection arrangement are possible. For example, the display 1000 may include connective end portions on multiple row and column electrodes, which can in turn connected to single or multiple bus lines in the border area 300. The arrangement of FIG. 4A is merely provided an as an example.

Referring to FIG. 4C, the end portion 401b of the row electrode 401 is patterned as an electrically conductive mesh 410. The conductive mesh 410 in the embodiment shown in FIGS. 4A and 4C has a regular pattern, but of course irregular patterns are also possible, and the conductive mesh pattern 410 is only provided as an example. The electrically conductive mesh 410 includes a plurality of conductive traces 415 defining a plurality of interstices 420 therebetween. The conductive traces 415 in the mesh 410 are interconnected to the active portion 401a of the row electrode 401, and have substantially the same uniform distribution of intersecting electrically conductive nanowires, so the conductive traces 415 have substantially the same first sheet resistance as the active area 401a of the row electrode 401. The interstices 420, which expose the surface 701 of the polymeric film substrate 700, create a patterned dielectric region 450 interspersed with the conductive traces 415 in the mesh 410. The interstices 420 are substantially non-conductive, and the ratio of the area in the end portion 401b occupied by the conductive mesh 410 to the area occupied by the patterned dielectric region 450 is selected such that the patterned dielectric region 450 has a second sheet resistance that is higher than the first sheet resistance of the traces 415 in the conductive mesh 410. In some embodiments, which are not intended to be limiting, the conductive traces 415 are about 2 microns wide, and the ratio of the area occupied by the interstices 420 in the patterned dielectric region 450 to the area occupied by the conductive mesh 410 is about 1:1 to about 10:1.

As shown in FIGS. 4A and 4C, the second end portion 803 of the bus line 801 terminates in and electrically connects to the end portion 401b of the row electrode 401. As shown in the embodiment of FIG. 4D, this electrical connection can be formed by substantially covering the plurality of interconnected conductive traces 415 and the patterned dielectric layer 450 with the metal end portion 803 such that the second end portion 803 makes electrical contact with the conductive traces 415 of the end portion 401b of the row electrode 401.

As noted above, the end portion 803 of the bus line 801 is a metal selected from Ag, Au, Cu, ITO, ATO, and alloys and combinations thereof. To ensure good adhesion and a robust electrical interconnection between the metal end portion 803 of the bus line 801 and the metal traces 415 of the end portion 401b, the metal end portion 803 should be applied to cover the resist layer 452 overlying the metal traces, and should also extend between the metal traces 415 and make contact with the surface 701 in interstices 420 in the patterned dielectric region 450. As shown in FIG. 4C, when applied to form the electrical interconnection the metal end portion 803 of the bus line 801 contacts the resist layer 452, the sides 416 of the nanowire-containing metal traces 415, and the polymeric surface 701 of the substrate 700 in the interstices 420 of the patterned dielectric region 450. In some embodiments the adhesion between the resist material 452 and the metal end portion 803 can be relatively poor. To enhance adhesion between the metal end portion 803 and the end portion 401b, the ratio of the area of the patterned dielectric layer 450 to the area of the conductive metal mesh 410 in the end portion 410b should be as large as possible as long as electrical interconnection is maintained, and in some embodiments the ratio should be about 1 to about 1, or about 10 to about 1.

To further enhance the adhesion between the polymeric substrate surface 701 and the metal end portion 803 in the interstices 420 of the patterned dielectric region 450, in some embodiments the surface 701 may optionally be treated to roughen all or a portion of the surface present in interstices 420 in the patterned dielectric region 450 by, for example, a corona treatment, prior to application of the metal end portion 803.

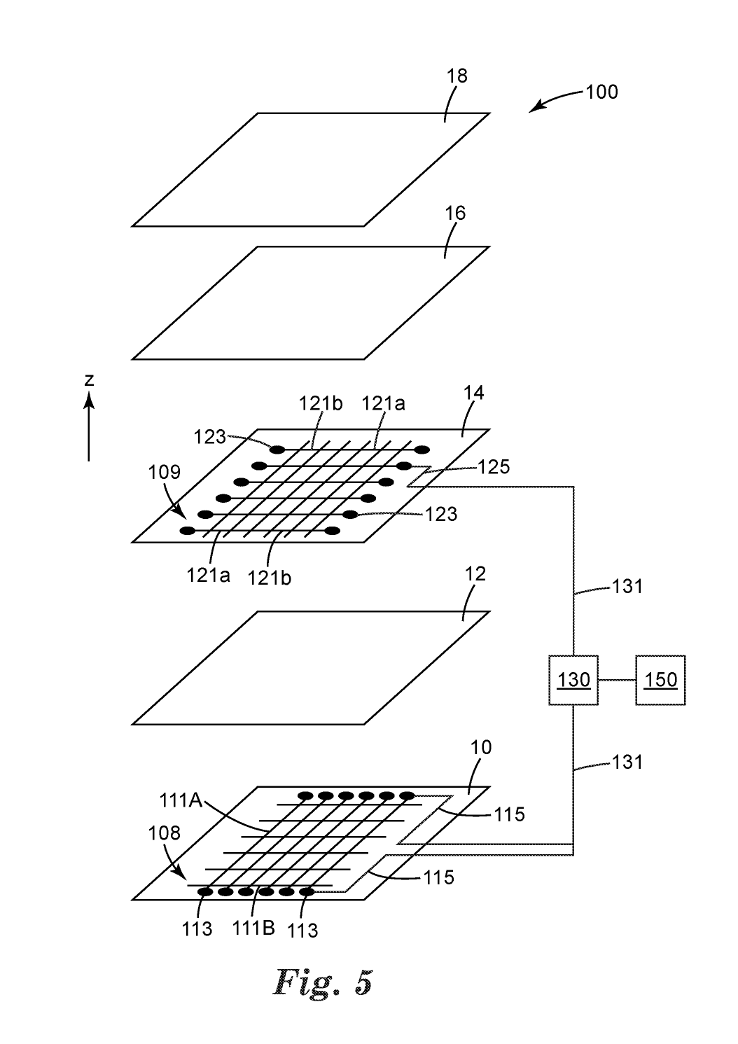

FIG. 5 is an exploded perspective view of an exemplary capacitive touch sensor panel 100 formed from a first transparent polymeric film 110 having thereon a first transparent conductive pattern 108 including overlapping transparent conductive sense traces 111A and 111B. Opposed ends of some of the conductive sense traces 111A terminate in contact pads 113, which are in turn electrically connected to metal interconnect traces 115. The metal interconnect traces 115 may in turn be connected to flexible circuits 131 so that output values from the conductive sense traces 111A, 111B can be transmitted to a controller 130 including sensing and control circuit elements, and the resulting image displayed by a host computer 150.

The capacitive touch sensor panel 100 further includes a dielectric layer 112, which in some non-limiting embodiments may be a polymeric film or a layer of an optically clear adhesive. The dielectric layer 112 separates the first transparent conductive pattern 108 from a second transparent conductive pattern 109 on a second polymeric film 114. The second transparent conductive pattern 109 includes overlapping conductive sense traces 121A, 121B, at least a portion of which terminate in contact pads 123. The contact pads 123 are connected to metal interconnect traces 125, which in turn may be connected to flexible circuits 131 so that output values from the conductive sense traces 121 can be transmitted to the controller 130 and the resulting image displayed by a host computer 150. A second transparent polymeric film or optically clear adhesive layer 116 separates the second transparent conductive pattern 109 from a layer of a cover glass 118 to form a display device.

In another aspect, the present disclosure is directed to a method for bonding a nanowire-containing electrode to a metal interconnect trace. One embodiment of the method includes coating a polymeric substrate with a conductive layer including nanowires, and then applying a pattern on the conductive layer with a resist matrix material to generate on the substrate one or more first regions of exposed conductive layer and one or more second regions of resist matrix material (FIG. 1).

Once the resist matrix material is hardened or cured, the pattern of resist matrix material is overcoated with a strippable polymer layer, which is then hardened or cured (FIG. 2).

The strippable polymer layer is then peeled from the substrate to remove the exposed conductive layer from the substrate in the one or more first regions that are not overlain by the resist matrix material, which forms a patterned conductive layer on the substrate (FIG. 3). The patterned conductive layer includes nanowires overlain by the resist matrix material.

As shown in FIG. 4A, the patterned nanowire-containing conductive layer may include contact pads with mesh-patterned conductive traces having a first sheet resistance. The conductive traces are interspersed with interstitial areas forming a patterned dielectric region having a second sheet resistance higher than the first sheet resistance. In the contact pads a ratio of the area of the patterned dielectric layer to the area of the conductive metal mesh is about 3 to about 1.

A corona treatment may optionally be performed to roughen the exposed substrate in the interstices in the patterned dielectric region.

The contact pad is bonded to a metallic interconnect trace to form an electrical interconnection. In the bonding step a metal selected from Ag, Au, Cu, ITO, ATO, and mixtures and alloys thereof is applied on the contact pads to coat the mesh-patterned metallic traces and the patterned dielectric region such that the metal contacts the substrate surface in the interstices of the patterned dielectric region.

Various embodiments of the invention have been described. These and other embodiments are within the scope of the following claims.

1. A capacitive touch sensitive apparatus, comprising:
a touch sensitive viewing area, the touch sensitive apparatus configured to detect a location of a touch applied to the touch sensitive viewing area by detecting a change in a coupling capacitance;
a border area surrounding the touch sensitive viewing area; and
an electrically conductive first electrode comprising an active portion disposed in and extending across the touch sensitive viewing area and an end portion at an end of the first electrode disposed in the border area for connection to a controller, the active portion of the first electrode having a substantially uniform first sheet resistance across the viewing area, the end portion of the first electrode patterned in the form of an electrically conductive mesh comprising a plurality of interconnected conductive traces defining a plurality of interstices therebetween, wherein the traces have substantially the first sheet resistance, and the interstices have a higher second sheet resistance.

2. The capacitive touch sensitive apparatus of claim 1 further comprising a first bus line disposed in the border area, a first end portion of the first bus line terminating at a connection region in the border area for connection to a controller, an opposite second end portion of the first bus line terminating at and substantially covering the plurality of interconnected conductive traces and the plurality of interstices, the end portion of the first bus making electrical contact with the conductive traces of the end portion of the first electrode.

3. The capacitive touch sensitive apparatus of claim 1, wherein the active portion of the first electrode and the interconnected conductive traces of the end portion of the first electrode comprises a substantially same uniform distribution of intersecting electrically conductive nanowires.

4. The capacitive touch sensitive apparatus of claim 1, wherein the interstices are substantially electrically non-conductive.

5. The capacitive touch sensitive apparatus of claim 1 further comprising a patterned dielectric layer disposed on and in registration and co-extensive with the electrically conductive mesh.

6. The capacitive touch sensitive apparatus of claim 1, wherein the electrically conductive first electrode is optically transparent.

7. A capacitive touch sensitive apparatus, comprising:
an optically transparent substrate defining a touch sensitive viewing area surrounded by a border area;
a plurality of spaced apart electrically conductive optically transparent first electrodes disposed on the substrate in the touch sensitive area and extending along a first direction (x);
a plurality of spaced apart electrically conductive optically transparent second electrodes disposed on the substrate in the touch sensitive area and extending along a different second direction (y), the touch sensitive apparatus being configured to detect a location of a touch applied in the touch sensitive area by detecting a change in a coupling capacitance between a first and a second electrode traversing each other near the touch location, each first and second electrode comprising a plurality of intersecting electrically conductive nanowires, each first and second electrode comprising an active portion disposed in and extending across the touch sensitive viewing area and an end portion at an end of the electrode disposed on the substrate in the border area, the end portion patterned in the form of an electrically conductive regular mesh comprising a plurality of interconnected conductive traces defining a plurality of insulative interstices therebetween; and
a plurality of electrically conductive bus lines disposed on the substrate in the border area, each bus line having a first end portion terminating at a connection region in the border area for connection to a controller and an opposite second end portion terminating at and substantially covering the plurality of interconnected conductive traces and the plurality of insulative interstices of a corresponding first or second electrode, the second end portion of the bus adhered to the substrate in the plurality of interstices.

8. A capacitive touch sensitive apparatus, comprising:
an electrically conductive unitary first electrode having a middle portion extending between opposing first and second end portions, the first electrode comprising a substantially uniform distribution of intersecting electrically conductive nanowires, the nanowires in the first end portion patterned in the form of an electrically conductive regular mesh comprising a plurality of interconnected regularly arranged conductive traces defining a plurality of interstices therebetween, the traces having a first sheet resistance, the interstices having a higher second sheet resistance.

9. The capacitive touch sensitive apparatus of claim 8, wherein the interstices are substantially electrically non-conductive.

10. The capacitive touch sensitive apparatus of claim 8, wherein the nanowires in the second end portion are patterned in the form of an electrically conductive regular mesh comprising a plurality of interconnected regularly arranged conductive traces defining a plurality of interstices therebetween, the traces having a third sheet resistance, the interstices having a higher fourth sheet resistance.
